(19) United States
(12) Patent Application Publication
(10) Pub. No.: US 2025/0329054 A1
(43) Pub. Date: Oct. 23, 2025

(54) COMPRESSED FOVEATION SENSING SYSTEMS

(71) Applicant: QUALCOMM Incorporated, San Diego, CA (US)

(72) Inventors: Shrey Shailesh GADIYA, Bengaluru (IN); Saurabh AGGARWAL, Bengaluru (IN); Abhijeet DEY, Bengaluru (IN)

(21) Appl. No.: 18/639,501

(22) Filed: Apr. 18, 2024

(51) Int. Cl. G06T 9/00; G06T 3/40

(52) U.S. Cl. CPC G06T 9/00; G06T 3/40

(57) ABSTRACT

Systems and techniques are described for processing images. For example, a computing device can obtain (e.g., from an image sensor) sensor data for a frame associated with a scene. The computing device can generate a first portion of the frame (having a first resolution) based on information corresponding to a first region of interest (ROI). The computing device can downsample a second portion of the frame from the sensor data to a second resolution that is lower than the first resolution. The first portion represents a first field of view (FOV) and the second portion represents a second FOV that is larger than the first FOV. The computing device can compress the first portion based on information in the second portion of the frame corresponding to the first ROI. The computing device can output the compressed first portion of the frame and the second portion of the frame.

### FIELD

The present disclosure generally relates to capture and processing of images or frames. For example, aspects of the present disclosure relate to compressed foveated sensing systems and techniques.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for performing compressed foveation. According to aspects described herein, devices using the disclosed compressed foveation can reduce bandwidth and power consumption based on reducing bandwidth of fovea regions. According to at least one example, a method is provided for generating one or more frames. The method includes: capturing, using an image sensor, sensor data for a frame associated with a scene; generating a first portion of the frame from the sensor data based on information corresponding to a first region of interest (ROI), the first portion having a first resolution; downsampling a second portion of the frame from the sensor data to a second resolution that is lower than the first resolution, wherein the first portion represents a first field of view (FOV) and the second portion represents a second FOV that is larger than the first FOV; compressing the first portion of the frame based on information in the second portion of the frame corresponding to the first ROI; and outputting the compressed first portion of the frame and the second portion of the frame.

In another example, an apparatus for generating one or more frames is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: obtain sensor data for a frame associated with a scene; generate a first portion of the frame from the sensor data based on information corresponding to a first ROI, the first portion having a first resolution; downsample a second portion of the frame from the sensor data to a second resolution that is lower than the first resolution, wherein the first portion represents a first FOV and the second portion represents a second FOV that is larger than the first FOV; compress the first portion of the frame based on information in the second portion of the frame corresponding to the first ROI; and output the compressed first portion of the frame and the second portion of the frame.

In another example, a non-transitory computer-readable medium is provided having stored thereon instructions that, when executed by at least one processor, cause the at least one processor to: obtain sensor data for a frame associated with a scene; generate a first portion of the frame from the sensor data based on information corresponding to a first ROI, the first portion having a first resolution; downsample a second portion of the frame from the sensor data to a second resolution that is lower than the first resolution, wherein the first portion represents a first FOV and the second portion represents a second FOV that is larger than the first FOV; compress the first portion of the frame based on information in the second portion of the frame corresponding to the first ROI; and output the compressed first portion of the frame and the second portion of the frame.

In another example, an apparatus for generating one or more frames is provided. The apparatus includes: means for capturing sensor data for a frame associated with a scene; means for generating a first portion of the frame from the sensor data based on information corresponding to a first region of interest (ROI), the first portion having a first resolution; means for downsampling a second portion of the frame from the sensor data to a second resolution that is lower than the first resolution, wherein the first portion represents a first field of view (FOV) and the second portion represents a second FOV that is larger than the first FOV; means for compressing the first portion of the frame based on information in the second portion of the frame corresponding to the first ROI; and means for outputting the compressed first portion of the frame and the second portion of the frame.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a diagram illustrating an example of an image capture and processing system, in accordance with some examples;

FIG. 2A is a diagram illustrating an example of a quad color filter array, in accordance with some examples;

FIG. 2B is a diagram illustrating an example of a binning pattern resulting from application of a binning process to the quad color filter array of FIG. 2A, in accordance with some examples;

FIG. 3 is a diagram illustrating an example of binning of a Bayer pattern, in accordance with some examples;

FIG. 4 is a diagram illustrating an example of an extended reality (XR) system, in accordance with some examples;

FIG. 5 is a block diagram illustrating an example of an XR system with fovea compression in accordance with some aspects of the disclosure;

FIGS. 6A and 6B are conceptual illustrations of frames with different foveation regions in accordance with some aspects of the disclosure;

FIG. 7 is a conceptual diagram of a system for compressing foveated streams in accordance with some aspects of the disclosure;

FIG. 8 is a conceptual diagram of a system for decompressing foveated streams in accordance with some aspects of the disclosure;

FIG. 9 is a block diagram of an XR system including an image sensor configured to perform compressed foveated sensing in accordance with some aspects of the disclosure;

FIG. 10 is a block diagram of another XR system configured to perform compressed foveated sensing in accordance with some aspects of the disclosure;

FIG. 11 is a block diagram of another XR system configured to perform compressed foveated sensing in accordance with some aspects of the disclosure;

FIG. 12 is a block diagram illustrating an example of an XR system with multi-fovea compression in accordance with some aspects of the disclosure;

FIG. 13 is a block diagram illustrating an example of an XR system with multi-fovea decompression in accordance with some aspects of the disclosure;

FIG. 14 is a flow diagram illustrating an example of a process for generating one or more compressed frames using foveated sensing, in accordance with some examples; and

FIG. 15 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices (e.g., extended reality (XR) devices such as virtual reality (VR) devices, augmented reality (AR) devices, mixed reality (MR) devices, etc., mobile phones, wearable devices such as smart watches, smart glasses, etc., tablet computers, connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an ISP of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

An XR device (e.g., a VR headset or head-mounted display (HMD), an AR headset or HMD, etc.) can output high fidelity images at high resolution and at high frame rates. In XR environments, users are transported into digital worlds where their senses are fully engaged and smooth motion is essential to prevent motion sickness and disorientation, which are common issues experienced at lower frame rates. By displaying images at a high frame rate, such as at 90 frames per second (FPS) or above, XR devices can minimize latency, maintain synchronization between the user movements and the visual feedback, and ensure low end-to-end processing time and reduce latency. Higher frame rates and low latency result in a more realistic and comfortable experience and ensure that human neural processing is engaged within the XR environment. Otherwise, the disconnect between the XR environment and the visual feedback received by the user creates motion sickness, disorientation, and nausea.

One application of XR devices is visual see-through (VST), which refers to the capability of XR devices, such as AR glasses or MR headsets, to overlay digital content seamlessly onto the user's real-world view. VST technology enables users to see and interact with their physical surroundings while augmenting them with virtual elements. By tracking the user's head movements and adjusting the position of digital content accordingly, VST technology ensures that virtual objects appear anchored to the real world, creating a convincing and integrated mixed reality experience.

Capturing images with varying resolutions and/or at varying frames rates can lead to a large amount of power consumption and bandwidth usage for systems and devices. For instance, a 16 megapixel (MP) or 20 MP image sensor capturing frames at 90 FPS can require 5.1 to 6.8 Gigabits per second (Gbps) of additional bandwidth. However, such a large amount of bandwidth may not be available on certain devices (e.g., XR devices).

Systems, apparatuses, processes (also referred to as methods), and computer-readable media (collectively referred to as “systems and techniques”) are described herein for performing foveated sensing. For example, foveation is a process for varying detail in an image based on the fovea (e.g., the center of the eye's retina) that can identify salient parts of a scene (e.g., a fovea region) and peripheral parts of the scene (e.g., a peripheral region). In some aspects, an image sensor can be configured to capture a part of a frame in high resolution, which is referred to as a foveated region or a region of interest (ROI), and other parts of the frame at a lower resolution using various techniques (e.g., pixel binning), which is referred to as a peripheral region. In some aspects, an image signal processor can process a foveated region or ROI at a higher resolution and a peripheral region at a lower resolution. In either of such aspects, the image sensor and/or the image signal processor (ISP) can produce high-resolution output for a foveated region where the user is focusing (or is likely to focus) and can produce a low-resolution output (e.g., a binned output) for the peripheral region. In some cases, the peripheral region can overlap the foveated region and the overlapping pixels can be used in the encoding and compressing techniques described herein.

When performing foveated sensing, an image sensor can send two or more streams of frame data (e.g., frames) based on levels of foveation. The two or more streams are processed separately and simultaneously. Although foveated sensing can reduce power and bandwidth on a physical layer (PHY), there is a need to further reduce power and bandwidth to support ever-increasing requirements of camera resolutions. For example, there is need to reduce power and bandwidth for memory (e.g., Double Data Rate Synchronous Dynamic Random-Access (DDR) memory) hops between different ISP cores and between ISP and other processor cores (e.g., graphics processing unit (GPU), data processing unit (DPU), and/or other processor cores). There is a need for techniques that can compress frame data for power and bandwidth reduction that is universal and can work across multiple formats (e.g., sRGB, YUV444, YUV420, Bayer, etc.) based on application or original equipment manufacturer (OEM) requirements.

Various aspects disclosed herein can use foveated sensing systems and techniques to reduce bandwidth and power consumption of a system, such as an XR system, a mobile device or system, a system of a vehicle, or other systems. The disclosed systems and techniques enable an XR system to have sufficient bandwidth to enable applications (e.g., VST applications) that use high-quality frames or images (e.g., high-definition (HD) images or video) and synthesize the high-quality frames or images with generated content, thereby creating mixed reality content. The terms frames and images are used herein interchangeably.

According to various aspects of the disclosure, the systems and techniques can compress a fovea region of a frame based on downsampled portions in the peripheral frame to remove redundant information common to both the fovea region and the peripheral region. In one illustrative example, a peripheral frame is downsampled at a 4:1 ratio and a pixel value of the downsampled peripheral region can be subtracted from the corresponding pixels of the fovea frame.

In some aspects, an image sensor can include a compressor for compressing the fovea region and can reduce the bandwidth consumed by a display subsystem such as a Mobile Industry Processor Interface (MIPI) display serial interface (DSI). In some cases, compressing the fovea region of a frame can reduce the number of bits (e.g., bandwidth) required for transmitting the foveated frame to an image signal processor. In some other aspects, an image signal processor can include a compressor for compressing the fovea region and can reduce the bandwidth consumed by a memory subsystem such as DDR memory. For example, the low-resolution pixels of the peripheral region may include the fovea region and the systems and techniques may compress pixels in the high-resolution fovea region based on the corresponding low-resolution pixels. In both aspects, reducing the bandwidth allows additional headroom for higher resolution content and can reduce the power consumed by the device, increase frame rate, and reduce latency. For example, writing less data to a memory (e.g., DDR memory) decreases latency. In some cases, the systems and techniques can include multiple levels of foveation, such as with a fovea region corresponding to the focal region and having a high resolution, a medial region that borders the fovea region and having a medial resolution, and a peripheral region including the entire FOV.

In some aspects, an image signal processor can include a decompressor for decompressing the fovea region. The decompressor can use information in the peripheral region to restore the content in the fovea region without loss of quality. In some cases, the fovea region may also be compressed in a lossy or lossless manner, further increasing bandwidth savings.

Various aspects of the application will be described with respect to the figures.

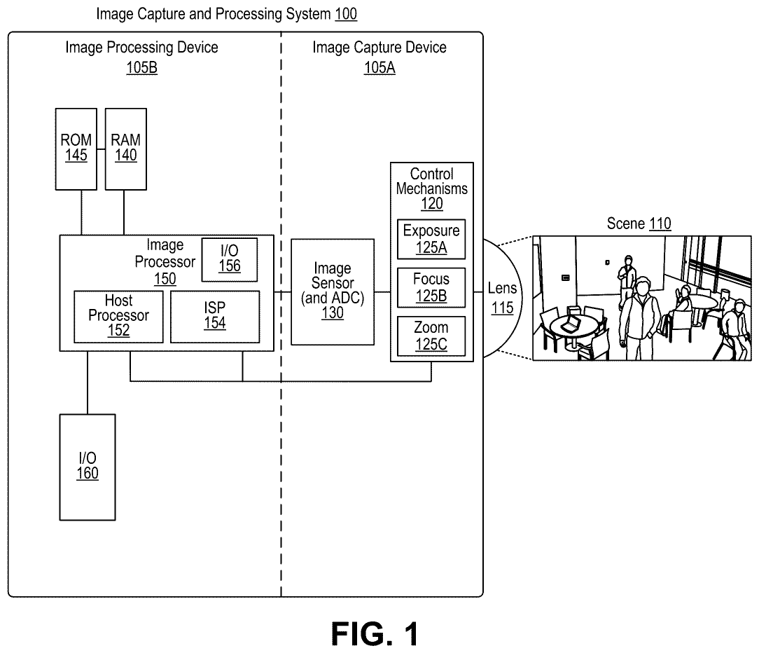

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, high dynamic range (HDR), depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f-stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

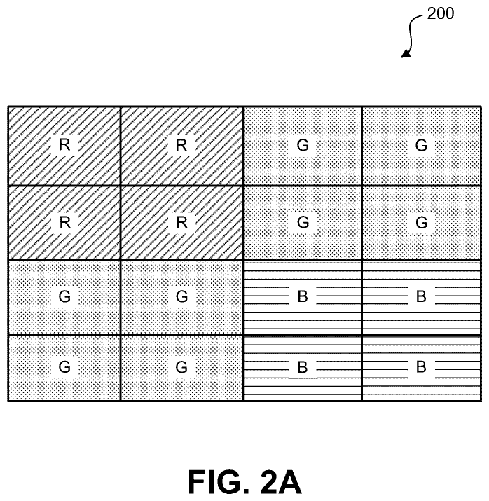

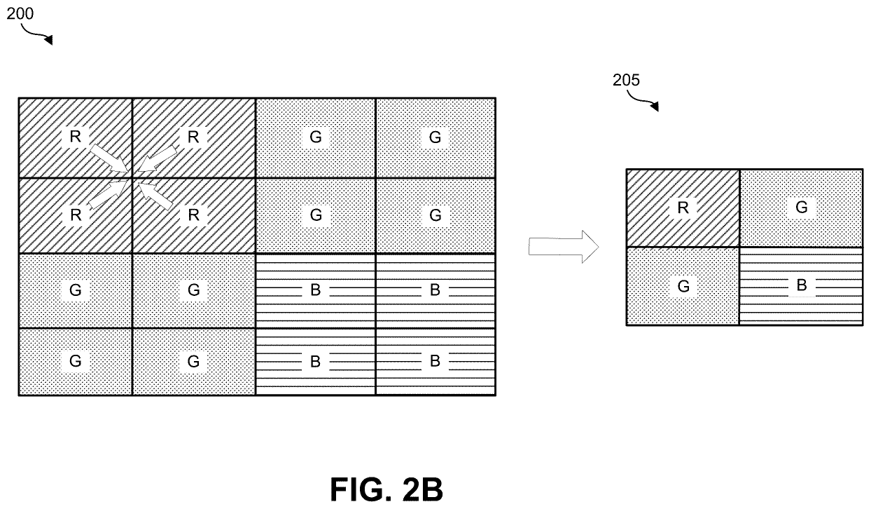

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. FIG. 2A is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2A is repeated for the entire array of photodiodes of a given image sensor. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for PDAF. The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more ISPs (including ISP 154), one or more host processors (including host processor 152), and/or one or more of any other type of processor 1510 discussed with respect to the computing system 1500. The host processor 152 can be a digital signal processor (DSP) and/or other type of processor. The image processor 150 may store image frames and/or processed images in random access memory (RAM) 140/1525, read-only memory (ROM) 145/1520, a cache 1512, a memory unit 1515, another storage device 1530, or some combination thereof.

In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), GPUs, broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a MIPI (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some implementations, such as the quad color filter array 200 shown in FIG. 2A. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 2B (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 2B is a diagram illustrating an example of a binning pattern 205 resulting from application of a binning process to the quad color filter array 200. The example illustrated in FIG. 2B is an example of a binning pattern 205 that results from a 2×2 quad color filter array binning process, where an average of each 2×2 set of pixels in the quad color filter array 200 results in one pixel in the binning pattern 205. For example, an average of the four pixels captured using the 2×2 set of red (R) color filters in the quad color filter array 200 can be determined. The average R value can be used as the single R component in the binning pattern 205. An average can be determined for each 2×2 set of color filters of the quad color filter array 200, including an average of the top-right pair of 2×2 green (G) color filters of the quad color filter array 200 (resulting in the top-right G component in the binning pattern 205), the bottom-left pair of 2×2 G color filters of the quad color filter array 200 (resulting in the bottom-left G component in the binning pattern 205), and the 2×2 set of blue (B) color filters (resulting in the B component in the binning pattern 205) of the quad color filter array 200.

The size of the binning pattern 205 is a quarter of the size of the quad color filter array 200. As a result, a binned image resulting from the binning process is a quarter of the size of an image processed without binning. In one illustrative example where a 48 megapixel (48 MP or 48 M) image is captured by the image sensor 130 using a 2×2 quad color filter array 200, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 200 pattern to the Bayer color filter array pattern. The remosaicing of the quad color filter array 200 pattern to a Bayer color filter array pattern allows an image captured using the quad color filter array 200 to be processed by ISPs that are designed to process images captured using a Bayer color filter array pattern.

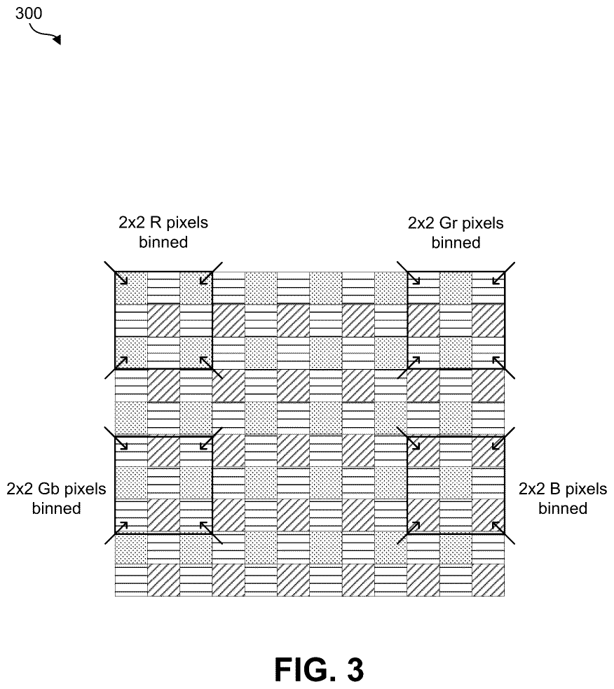

FIG. 3 is a diagram illustrating an example of a binning process applied to a Bayer pattern of a Bayer color filter array 300. As shown, the binning process bins the Bayer pattern by a factor of two both along the horizontal and vertical direction. For example, taking groups of two pixels in each direction (as marked by the arrows illustrating binning of a 2×2 set of red (R) pixels, two 2×2 sets of green (Gr) pixels, and a 2×2 set of blue (B) pixels), a total of four pixels are averaged to generate an output Bayer pattern that is half the resolution of the input Bayer pattern of the Bayer color filter array 300. The same operation may be repeated across all of the red, blue, green (beside the red pixels), and green (beside the blue pixels) channels.

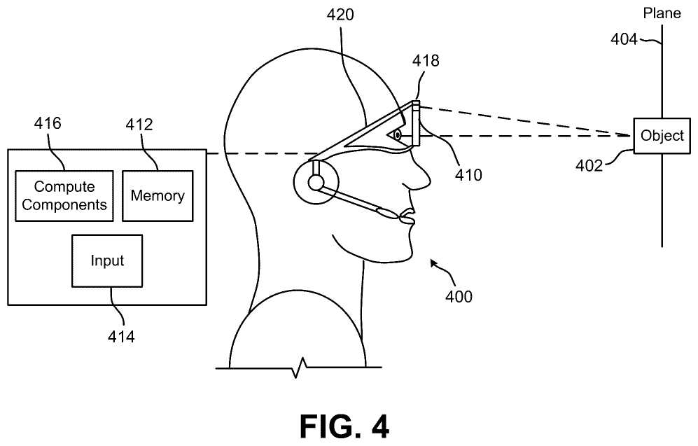

FIG. 4 is a diagram illustrating an example of an extended reality system 420 being worn by a user 400. While the extended reality system 420 is shown in FIG. 4 as AR glasses, the extended reality system 420 can include any suitable type of XR system or device, such as an HMD or other XR device. The extended reality system 420 is described as an optical see-through AR device, which allows the user 400 to view the real world while wearing the extended reality system 420. For example, the user 400 can view an object 402 in a real-world environment on a plane 404 at a distance from the user 400. The extended reality system 420 has an image sensor 418 and a display 410 (e.g., a glass, a screen, a lens, or other display) that allows the user 400 to see the real-world environment and also allows AR content to be displayed thereon. While one image sensor 418 and one display 410 are shown in FIG. 4, the extended reality system 420 can include multiple cameras and/or multiple displays (e.g., a display for the right eye and a display for the left eye) in some implementations. In some aspects, the extended reality system 420 can include an eye sensor for each eye (e.g., a left eye sensor, a right eye sensor) configured to track a location of each eye, which can be used to identify a focal point with the extended reality system 420. AR content (e.g., an image, a video, a graphic, a virtual or AR object, or other AR content) can be projected or otherwise displayed on the display 410. In one example, the AR content can include an augmented version of the object 402. In another example, the AR content can include additional AR content that is related to the object 402 or related to one or more other objects in the real-world environment.

As shown in FIG. 4, the extended reality system 420 can include, or can be in wired or wireless communication with, compute components 416 and a memory 412. The compute components 416 and the memory 412 can store and execute instructions used to perform the techniques described herein. In implementations where the extended reality system 420 is in communication (wired or wirelessly) with the memory 412 and the compute components 416, a device housing the memory 412 and the compute components 416 may be a computing device, such as a desktop computer, a laptop computer, a mobile phone, a tablet, a game console, or other suitable device. The extended reality system 420 also includes or is in communication with (wired or wirelessly) an input device 414. The input device 414 can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 418 can capture images that can be processed for interpreting gesture commands.

The image sensor 418 can capture color images (e.g., images having red-green-blue (RGB) color components, images having luma (Y) and chroma (C) color components such as YCbCr images, or other color images) and/or grayscale images. As noted above, in some cases, the extended reality system 420 can include multiple cameras, such as dual front cameras and/or one or more front and one or more rear-facing cameras, which may also incorporate various sensors. In some cases, image sensor 418 (and/or other cameras of the extended reality system 420) can capture still images and/or videos that include multiple video frames (or images). In some cases, image data received by the image sensor 418 (and/or other cameras) can be in a raw uncompressed format, and may be compressed and/or otherwise processed (e.g., by an ISP or other processor of the extended reality system 420) prior to being further processed and/or stored in the memory 412. In some cases, image compression may be performed by the compute components 416 using lossless or lossy compression techniques (e.g., any suitable video or image compression technique).

In some cases, the image sensor 418 (and/or other camera of the extended reality system 420) can be configured to also capture depth information. For example, in some implementations, the image sensor 418 (and/or other camera) can include an RGB-depth (RGB-D) camera. In some cases, the extended reality system 420 can include one or more depth sensors (not shown) that are separate from the image sensor 418 (and/or other camera) and that can capture depth information. For instance, such a depth sensor can obtain depth information independently from the image sensor 418. In some examples, a depth sensor can be physically installed in a same general location as the image sensor 418, but may operate at a different frequency or frame rate from the image sensor 418. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

In some implementations, the extended reality system 420 includes one or more sensors. The one or more sensors can include one or more accelerometers, one or more gyroscopes, one or more inertial measurement units (IMUs), and/or other sensors. For example, the extended reality system 420 can include at least one eye sensor that detects a position of the eye that can be used to determine a focal region that the person is looking at in a parallax scene. The one or more sensors can provide velocity, orientation, and/or other position-related information to the compute components 416. As noted above, in some cases, the one or more sensors can include at least one IMU. An IMU is an electronic device that measures the specific force, angular rate, and/or the orientation of the extended reality system 420, using a combination of one or more accelerometers, one or more gyroscopes, and/or one or more magnetometers. In some examples, the one or more sensors can output measured information associated with the capture of an image captured by the image sensor 418 (and/or other camera of the extended reality system 420) and/or depth information obtained using one or more depth sensors of the extended reality system 420.

The output of one or more sensors (e.g., one or more IMUs) can be used by the compute components 416 to determine a pose of the extended reality system 420 (also referred to as the head pose) and/or the pose of the image sensor 418. In some cases, the pose of the extended reality system 420 and the pose of the image sensor 418 (or other camera) can be the same. The pose of image sensor 418 refers to the position and orientation of the image sensor 418 relative to a frame of reference (e.g., with respect to the object 402). In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some aspects, the pose of image sensor 418 and/or the extended reality system 420 can be determined and/or tracked by the compute components 416 using a visual tracking solution based on images captured by the image sensor 418 (and/or other camera of the extended reality system 420). In some examples, the compute components 416 can perform tracking using computer vision-based tracking, model-based tracking, and/or simultaneous localization and mapping (SLAM) techniques. For instance, the compute components 416 can perform SLAM or can be in communication (wired or wireless) with a SLAM engine (now shown). SLAM refers to a class of techniques where a map of an environment (e.g., a map of an environment being modeled by extended reality system 420) is created while simultaneously tracking the pose of a camera (e.g., image sensor 418) and/or the extended reality system 420 relative to that map. The map can be referred to as a SLAM map, and can be three-dimensional (3D). The SLAM techniques can be performed using color or grayscale image data captured by the image sensor 418 (and/or other camera of the extended reality system 420), and can be used to generate estimates of 6DOF pose measurements of the image sensor 418 and/or the extended reality system 420. Such a SLAM technique configured to perform 6DOF tracking can be referred to as 6DOF SLAM. In some cases, the output of one or more sensors can be used to estimate, correct, and/or otherwise adjust the estimated pose.

In some cases, the 6DOF SLAM (e.g., 6DOF tracking) can associate features observed from certain input images from the image sensor 418 (and/or other camera) to the SLAM map. 6DOF SLAM can use feature point associations from an input image to determine the pose (position and orientation) of the image sensor 418 and/or extended reality system 420 for the input image. 6DOF mapping can also be performed to update the SLAM Map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 418 and/or the extended reality system 420 can be determined by projecting features from the 3D SLAM map into an image or video frame and updating the camera pose from verified 4D-3D correspondences.

In one illustrative example, the compute components 416 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some examples, virtual objects (e.g., AR objects) can be registered or anchored to (e.g., positioned relative to) the detected features points in a scene. For example, the user 400 can be looking at a restaurant across the street from where the user 400 is standing. In response to identifying the restaurant and virtual content associated with the restaurant, the compute components 416 can generate a virtual object that provides information related to the restaurant. The compute components 416 can also detect feature points from a portion of an image that includes a sign on the restaurant, and can register the virtual object to the feature points of the sign so that the AR object is displayed relative to the sign (e.g., above the sign so that it is easily identifiable by the user 400 as relating to that restaurant).

The extended reality system 420 can generate and display various virtual objects for viewing by the user 400. For example, the extended reality system 420 can generate and display a virtual interface, such as a virtual keyboard, as an AR object for the user 400 to enter text and/or other characters as needed. The virtual interface can be registered to one or more physical objects in the real world. However, in many cases, there can be a lack of real-world objects with distinctive features that can be used as reference for registration purposes. For example, if a user is staring at a blank whiteboard, the whiteboard may not have any distinctive features to which the virtual keyboard can be registered. Outdoor environments may provide even less distinctive points that can be used for registering a virtual interface, for example based on the lack of points in the real world, distinctive objects being further away in the real world than when a user is indoors, the existence of many moving points in the real world, points at a distance, among others.

In some examples, the image sensor 418 can capture images (or frames) of the scene associated with the user 400, which the extended reality system 420 can use to detect objects and humans/faces in the scene. For example, the image sensor 418 can capture frames/images of humans/faces and/or any objects in the scene, such as other devices (e.g., recording devices, displays, etc.), windows, doors, desks, tables, chairs, walls, etc. The extended reality system 420 can use the frames to recognize the faces and/or objects captured by the frames and estimate a relative location of such faces and/or objects. To illustrate, the extended reality system 420 can perform facial recognition to detect any faces in the scene and can use the frames captured by the image sensor 418 to estimate a location of the faces within the scene. As another example, the extended reality system 420 can analyze frames from the image sensor 418 to detect any capturing devices (e.g., cameras, microphones, etc.) or signs indicating the presence of capturing devices, and estimate the location of the capturing devices (or signs).

The extended reality system 420 can also use the frames to detect any occlusions within a field of view (FOV) of the user 400 that may be located or positioned such that any information rendered on a surface of such occlusions or within a region of such occlusions are not visible to, or are out of a FOV of, other detected users or capturing devices. For example, the extended reality system 420 can detect the palm of the hand of the user 400 is in front of, and facing, the user 400 and thus within the FOV of the user 400. The extended reality system 420 can also determine that the palm of the hand of the user 400 is outside of a FOV of other users and/or capturing devices detected in the scene, and thus the surface of the palm of the hand of the user 400 is occluded from such users and/or capturing devices. When the extended reality system 420 presents any AR content to the user 400 that the extended reality system 420 determines should be private and/or protected from being visible to the other users and/or capturing devices, such as a private control interface as described herein, the extended reality system 420 can render such AR content on the palm of the hand of the user 400 to protect the privacy of such AR content and prevent the other users and/or capturing devices from being able to see the AR content and/or interactions by the user 400 with that AR content.

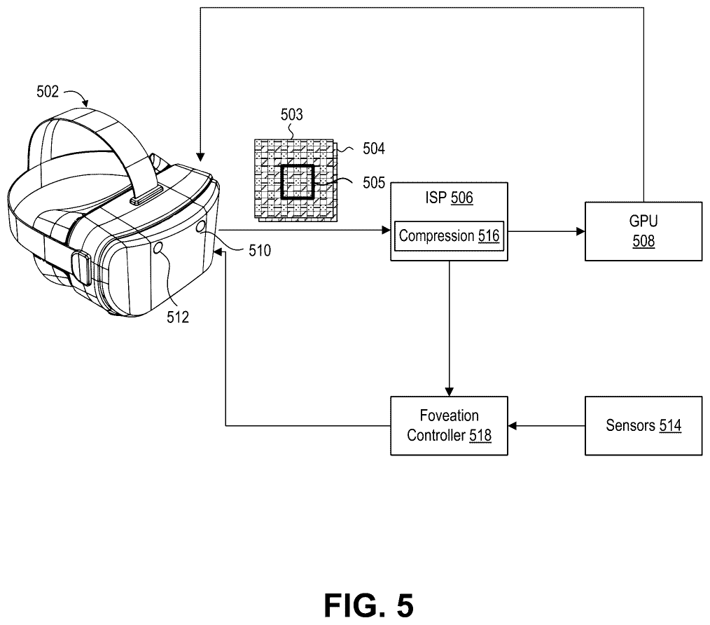

FIG. 5 illustrates an example of an XR system 502 with VST capabilities that can generate frames or images of a physical scene in the real-world by processing sensor data 503, 504 using an ISP 506 and a GPU 508. As noted above, virtual content can be generated and displayed with the frames/images of the real-world scene, resulting in mixed reality content. In some cases, the XR system 502 can include a memory (e.g., a cache memory, DDR, etc.) to store images between the various components. For example, the ISP 506 may store images in a memory (e.g., a cache memory, DDR, etc.) and the GPU 508 can retrieve the images from the memory to synthesize images for display within the XR system 502.

In the example XR system 502 of FIG. 5, the bandwidth requirement that is needed for VST in XR is high. There is also a high demand for increased resolution to improve the visual fidelity of the displayed frames or images, which requires a higher capacity image sensor, such as a 16 MP or 20 MP image sensor. Further, there is demand for increased framerate for XR applications, as lower framerates (and higher latency) can affect a person's senses and cause real world effects such as nausea. Higher resolution and higher framerates may result in an increased memory bandwidth, latency, and power consumption beyond the capacity of some existing memory systems.

In some aspects, an XR system 502 can include image sensors 510 and 512 (or VST sensors) corresponding to each eye. For example, a first image sensor 510 can capture the sensor data 503 and a second image sensor 512 can capture the sensor data 504. The two image sensors 510 and 512 can send the sensor data 503, 504 to the ISP 506. The ISP 506 processes the sensor data (to generate processed frame data) and passes the processed frame data to the GPU 508 for rendering an output frame or image for display. For example, the GPU 508 can augment the processed frame data by superimposing virtual data over the processed frame data.

In some cases, using an image sensor with 16 MP to 20 MP at 90 FPS may require 5.1 to 6.8 Gigabits per second (Gbps) of additional bandwidth for the image sensor. This bandwidth may not be available because memory (e.g., DDR memory) in current systems is typically already stretched to the maximum possible capacity. Improvements to limit the bandwidth, power, and memory are needed to support mixed reality applications using VST.

In some aspects, human vision sees only a fraction of the field of view at the center (e.g., 10 degrees) with high resolution. In general, the salient parts of a scene draw human attention more than the non-salient parts of the scene. Illustrative examples of salient parts of a scene include moving objects in a scene, people or other animated objects (e.g., animals), faces of a person, or important objects in the scene such as an object with a bright color.

In some aspects, systems and techniques may use foveation sensing to reduce bandwidth and power consumption of a system (e.g., an XR system, mobile device or system, a system of a vehicle, etc.). For example, the sensor data 503 and the sensor data 504 may be separated into two frames, processed independently, and combined at an output stage. For example, a fovea region 505 may be preserved with high fidelity and the peripheral region (e.g., the sensor data 503) may be downsampled to a lower resolution.

In some aspects, the ISP may include a compression engine 516 or a decompression engine (not shown). The compression engine 516 is configured to compress the fovea region 505 based on the peripheral region. In some aspects, the bits used in a low-resolution peripheral region frame may be used to compress the bits in a high-resolution fovea region.

The XR system 502 also may include a foveation controller 518 that receives motion information from one or more sensors 514 (e.g., an accelerometer, a gyrometer, etc.). The foveation controller 518 is configured to control the foveation of the XR system 502 based on the motion information (e.g., gaze movement, global motion applied to the XR system 502, etc.). The foveation controller 518 may also include various additional components to control foveation based on intrinsic information within the scene being captured by the image sensors 510 and the image sensors 512. For example, the foveation controller 518 may include object detection engines that identify objects that are moving within the scene, such as a person moving in the background.

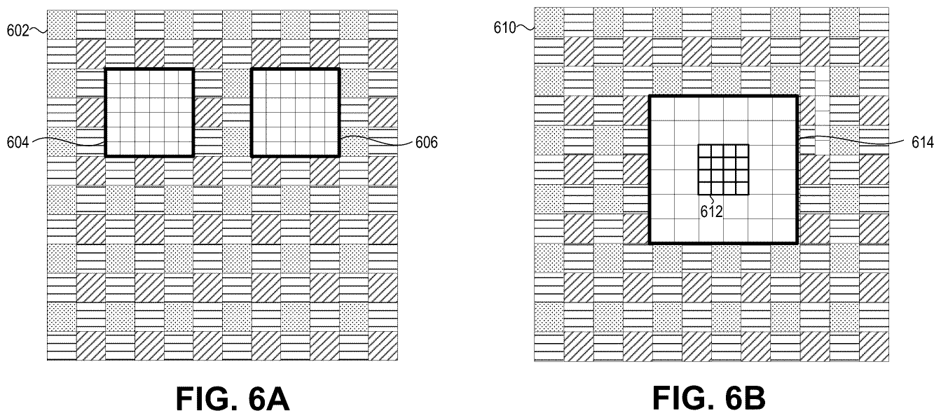

FIGS. 6A and 6B are conceptual illustrations of frames with different foveation regions in accordance with some aspects of the disclosure. FIG. 6A is a conceptual illustration of a frame 602 with a full FOV and includes a first fovea region 604 with a partial FOV, and a second fovea region 606 with a partial FOV. As shown in the frame 602, the fovea region 604 region is a focal region (e.g., an ROI) having a higher resolution than the frame 602. In one aspect, the fovea region 606 is another ROI (e.g., an area of local motion) and also has a higher resolution than the frame 602. For example, the XR system may detect that the local motion may cause the gaze of the user to change to the fovea region.

FIG. 6B in another conceptual illustration of a frame 610 with a full FOV and includes a first fovea region 612 that is within a second fovea region 614. The frame 610 has the lowest resolution, the first fovea region 612 has the highest resolution, and the second fovea region has an intermediate resolution. In this case, the fovea regions are gradients between the highest resolution and lowest resolution to reduce image artifacts and blending issues. The first fovea region 612, and the second fovea region 614 may also have a different frame rate (e.g., the frame 610 is output by an image sensor at 30 fps, the first fovea region 612 is output at 120 fps, and the second fovea region 614 is output at 60 fps). That is, the XR system can include multiple overlapping fovea regions that have different resolutions to improve image fidelity.

The XR system is configured to generate multiple streams of images having different resolutions. A stream refers to a sequence of data elements that are made available over time, such as a stream of images from an image sensor and often are used to represent continuous or dynamically changing data. Streams provide a flexible and efficient mechanism to handle potentially large or infinite datasets without loading the entire set of data (e.g., images) entirely into memory at once, and allow for sequential processing of data. The processing of streams allows applications to work with data incrementally, reducing memory usage and improving performance.

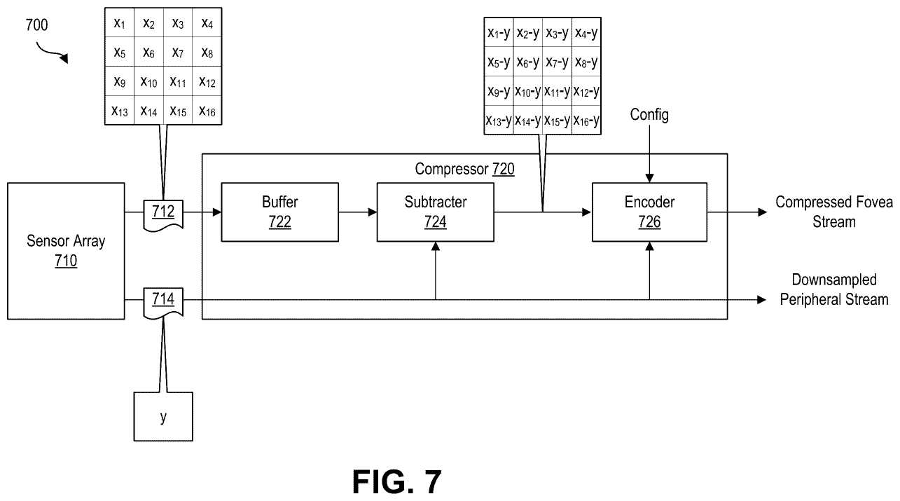

FIG. 7 is a conceptual diagram of a system 700 for compressing foveated streams in accordance with some aspects of the disclosure. In some aspects, the system 700 includes an image sensor 710 including a sensor array (e.g., a matrix of photodiodes) that is configured to generate one or more streams of frames (or images), such as a high-resolution fovea frame 712 and a low-resolution peripheral frame 714. The low-resolution peripheral frame 714 captures the full FOV of the image sensor 710, and the high-resolution fovea frame 712 captures a partial FOV associated with the fovea region (e.g., a salient portion of the full FOV). In the aspect illustrated in FIG. 7, the low-resolution peripheral frame 714 is downsampled by a factor of 4, resulting in a compression factor of 4². For example, pixels [x1, x2, . . . x16] illustrated in FIG. 7 in the high-resolution fovea frame 712 are downsampled into pixel [y] in the low-resolution peripheral frame 714. That is pixel y can be expressed as a transformation of the [x1, x2, . . . x16] such as y=H ([x1, x2, . . . x16])), where H is a transfer function. Examples of a transfer function include a median function, a bicubic interpolation, a floor function, binning, averaging, nearest neighbor interpolation, etc.

The system 700 may also include a compressor 720 for using the downsampled pixels from the low-resolution peripheral frame 714 to compress the high-resolution fovea frame 712. The compressor 720 includes a buffer 722, which is configured to buffer the streams and align corresponding frames in time.

The compressor 720 includes a subtracter 724 that is configured to subtract the values of the low-resolution peripheral frame 714 from corresponding values of the high-resolution fovea frame 712. For example, the subtracter 724 is configured to subtract the value [y] from each corresponding pixel [x1, x2, . . . x16] and yield differential pixels [(x1−y), (x2−y), . . . (x16−y)]. The differential pixels are then encoded by an encoder 726 using lossless or lossy techniques. For example, the encoder 726 may perform a lossless compression (e.g., Hufman coding, run-length encoding, etc.) or lossy compression (e.g., direct cosine transform, etc.) to generate a compressed fovea stream. In this case, the subtracter 724 reduces the bit depth by applying redundant information from the low-resolution peripheral frame 714 to the high-resolution fovea frame 712.

In some aspects, the compressor 720 can be configured within the image sensor 710 and is shown as separate for illustrative purposes. Including the compressor 720 into the image sensor 710 can further reduce the bandwidth between the image sensor 710 and an ISP (not shown). In other cases, the compressor 720 can also be included in the ISP because the stream of frames may be stored in a memory buffer, and compressing the fovea can reduce the bandwidth of memory systems (e.g., DDR memory).

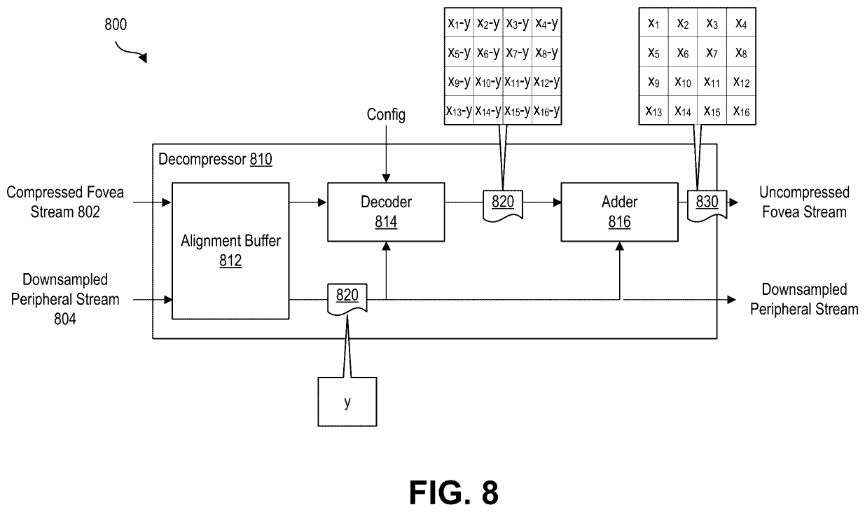

FIG. 8 is a conceptual diagram of a system 800 for decompressing foveated streams in accordance with some aspects of the disclosure. In some aspects, the system 800 includes a decompressor 810 that is configured to decompress at least a compressed fovea stream 802 based on a downsampled peripheral stream 804. In some aspects, the compressed fovea stream 802 and the downsampled peripheral stream 804 may be temporally misaligned and an alignment buffer 812 is configured to delay and temporally align the compressed fovea stream 802 and the downsampled peripheral stream 804.

The alignment buffer outputs the downsampled peripheral stream 804 and the decoder 814 and a decoder 814 is configured to decode and/or decompress the compressed fovea stream 802 into a differential stream 820. For example, the differential stream 820 may be the pixels from the fovea region that are reduced by the corresponding pixels in the compressed fovea stream 802 (e.g., pixel [y]). Differential pixels may also be referred to as a residual pixel and/or residue, and correspond to a difference between one or more values of a pixel. As shown in FIG. 8, the differential stream 820 corresponds to values [(x1−y), (x2−y), . . . (x16−y)] and are provided to an adder 816. The adder 816 is configured to inversely transform the differential pixels based on the transformation within the compressor (e.g., the compressor 720 in FIG. 7). In one aspect, the adder adds the value of the pixel [y] to each pixel in the differential stream 820 to generate an uncompressed fovea region 830. Ash shown in FIG. 8, the uncompressed fovea region 830 includes values [x1, x2, . . . x16] corresponding to the original fovea region in FIG. 7.

In some aspects, the decompressor 810 can be included in an ISP (e.g., ISP 124) as part of a front-end (not shown) or as part of an offline ISP (not shown). The front end provides an initial stage of processing that occurs to manipulate raw image sensor data captured by a camera. For example, the front end performs tasks such as demosaicing (e.g., converting raw sensor data into full-color images), color correction, white balance adjustment, noise reduction, and lens distortion correction. In one aspect, when an image sensor includes a compress, the decompressor 810 may be implemented in the front-end of the ISP).

In other aspects, the decompressor 810 can be part of an offline engine, which refers to image processing that occurs after the raw sensor data has been captured and stored. The offline engine may use computationally intensive algorithms and techniques for advanced image enhancement, feature extraction, object recognition, or other tasks that require deeper analysis of the image data. In some aspects, the offline engine may perform operations on the foveated regions (e.g., the uncompressed fovea region 830) to improve image fidelity, and may perform minimal or no operations on the peripheral region (e.g., the downsampled peripheral stream 804) that have less significance.

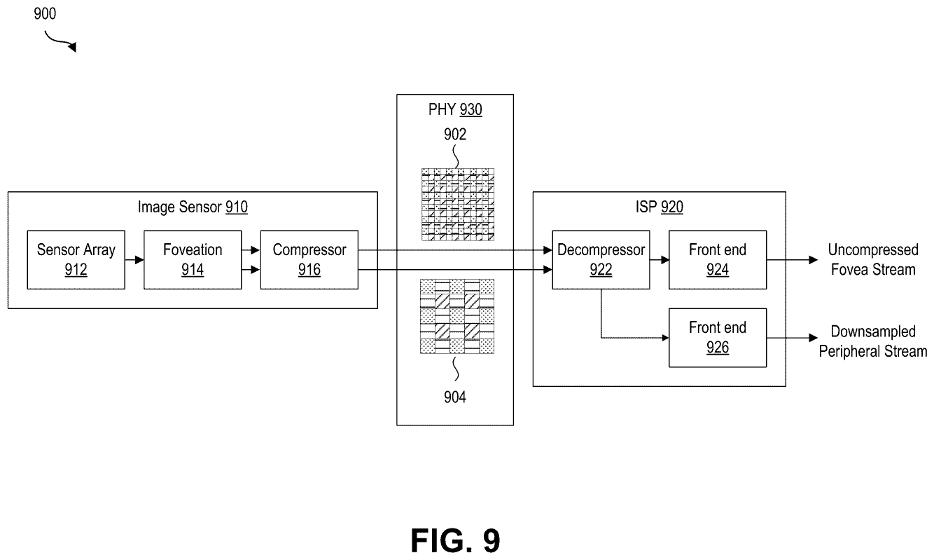

FIG. 9 is a block diagram of an XR system 900 including an image sensor configured to perform compressed foveated sensing in accordance with some aspects of the disclosure. In some aspects, the XR system 900 includes an image sensor 910, an ISP 920, and an interface 930 (e.g., a display interface such as a MIPI interface).

The image sensor 910 includes a sensor array 912 (e.g., an array of photodiodes that are exposed to light via a camera), a foveation controller 914, and a compressor 916. In some aspects, the image sensor 910 may be controlled by the ISP 920. For example, the sensor array 912 is configured to receive a mask or addresses associated with the sensor array. When the sensor array 912 outputs a frame (e.g., in conjunction with an ADC), the foveation controller 914 is configured to generate two frames. For example, a high-resolution fovea frame (e.g., the high-resolution fovea frame 712 in FIG. 7) can be generated based on the mask, coordinates, or address and corresponds sensor values provided by the sensor array 912. The sensor array 912 also generates a low-resolution peripheral frame (e.g., the low-resolution peripheral frame 714 in FIG. 7). In some aspects, the image sensor 910 can include a binner to bin values and downsample the full frame. The high-resolution fovea frame and the low-resolution peripheral frame are provided to the compressor 916, which further compresses the high-resolution fovea frame based on the pixels in the low-resolution peripheral frame. As noted above, the compressor 916 uses redundant information within the low-resolution peripheral frame to at least reduce the bit-depth of the high-resolution fovea frame.

The image sensor 910 can transmit the compressed frame 902 and the low-resolution peripheral frame 904 on the interface 930 to the ISP 920. The ISP 920 includes a decompressor 922 that uses the low-resolution peripheral frame 904 to decompress the compressed frame 902 to the high-resolution fovea frame. The decompressor 922 can provide the high-resolution fovea frame to a front end 924 for processing (e.g., demosaicing, lens distortion correction, etc.). The decompressor 922 also provides the low-resolution peripheral frame 904 to a front-end 926 for processing.

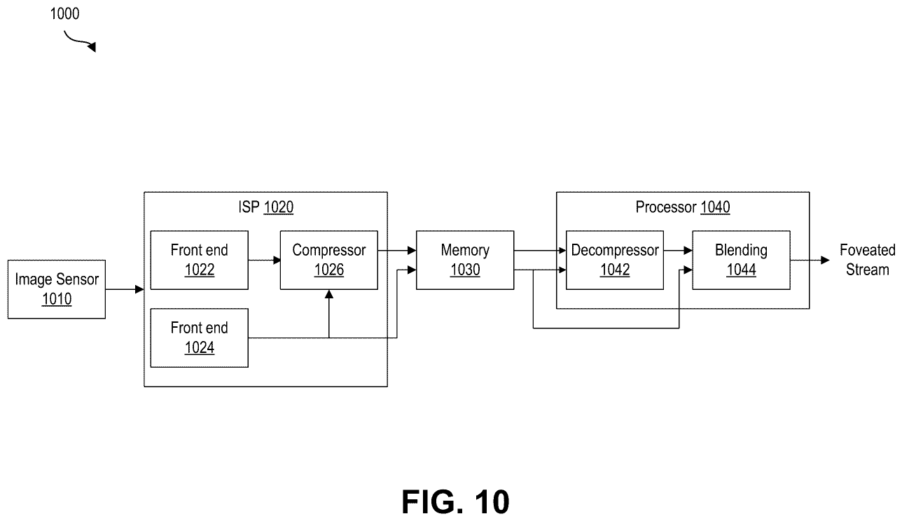

FIG. 10 is a block diagram of another XR system 1000 configured to perform compressed foveated sensing in accordance with some aspects of the disclosure. In some aspects, the XR system 1000 includes an image sensor 1010 that does not perform direct foveation and provides a high-resolution stream of images to the ISP 1020 via an interface (e.g., a MIPI interface).

The ISP 1020 includes a first front-end 1022 for generating a high-resolution fovea frame and a second front-end 1024 for generating a low-resolution peripheral frame. The high-resolution fovea frame and the low-resolution peripheral frame are provided to a compressor 1026 (e.g., the compressor 720 of FIG. 7). The compressor 1026 is configured to compress the high-resolution fovea frame based on different modification techniques. In one example, the compressor 1026 subtracts a downsampled value from values in the high-resolution fovea frame. The high-resolution fovea frame can be modified based on different techniques.

The compressed fovea frame and the low-resolution peripheral frame can then be stored in memory 1030 (e.g., a DDR memory). A processor 1040 may be configured to read back the compressed fovea frame and the low-resolution peripheral frame. In some aspects, the processor 1040 can be a processing core of a general-purpose processor, a GPU, or a neural processing unit (NPU). The processor 1040 includes a decompressor 1042 (e.g., the decompressor 810 in FIG. 8) that receives the compressed fovea frame and the low-resolution peripheral frame and decompresses the fovea frame into the high-resolution fovea frame. The high-resolution fovea frame and the low-resolution peripheral frame are provided to a blending engine 1044 to generate a foveated stream of images. For example, the blending engine 1044 may include upscaling engines to increase the resolution of the low-resolution peripheral frame and blend any differences. For example, the high-resolution fovea frame and the low-resolution peripheral frame may have photometric differences based on the various processing that can occur in the ISP 1020, and the blending engine 1044 is configured to blend the high-resolution fovea frame and low-resolution peripheral frame and synthesize a high fidelity image.

The reading of the compressed fovea frame and the low-resolution peripheral frame can reduce the number of read and corresponding write operations of the memory 1030, which can reduce the power consumption of the XR system 1000. In some aspects, the memory 1030 may also have insufficient bandwidth due to the size of the image streams and the frame rate. Compressing the fovea region can reduce the memory bandwidth consumed by this operation and prevent degradation of the XR system 1000 operation. For example, the XR system 1000 may skip frames if the bandwidth of the memory 1030 is exceeded. Skipping frames can create visual artifacts and decrease the playback experience.

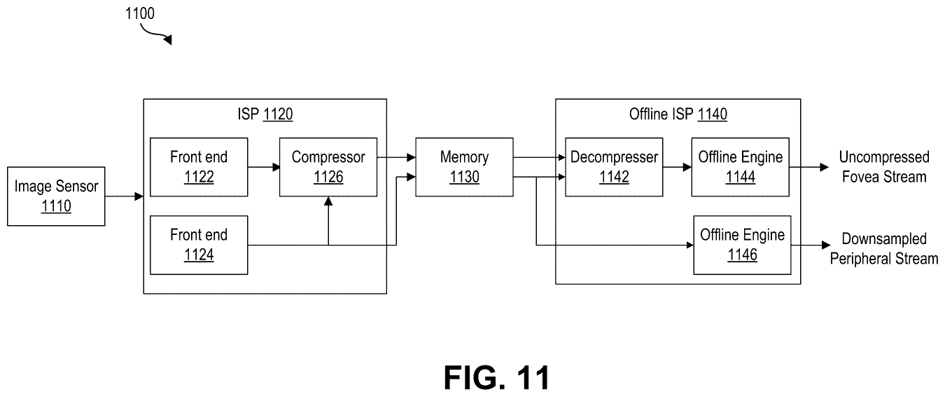

FIG. 11 is a block diagram of another XR system 1100 configured to perform compressed foveated sensing in accordance with some aspects of the disclosure. In some aspects, the XR system 1000 includes an image sensor 1110 that does not perform direct foveation and provides a high-resolution stream of images to the ISP 1120 via an interface (e.g., a MIPI interface) and an offline ISP 1140 is configured to enhance the stream of frames.

The ISP 1120 includes a first front end 1122 for generating a high-resolution fovea frame, and a second front end 1124 for generating a low-resolution peripheral frame. The high-resolution fovea frame and the low-resolution peripheral frame are provided to a compressor 1126 (e.g., the compressor 720 of FIG. 7). The compressor 1126 is configured to compress the high-resolution fovea frame based on different modification techniques. In one example, the compressor 1126 subtracts a downsampled value (e.g., downsampled values from the peripheral frame) from values in the high-resolution fovea frame. The high-resolution fovea frame can be modified based on different techniques.

The compressed fovea frame and the low-resolution peripheral frame can then be stored in memory 1130 (e.g., a DDR memory). The offline ISP 1140 may be configured to read back the compressed fovea frame and the low-resolution peripheral frame. In some aspects, the offline ISP 1140 includes a decompressor 1142 (e.g., the decompressor 810 in FIG. 8) that receives the compressed fovea frame and the low-resolution peripheral frame and decompresses the fovea frame into the uncompressed high-resolution fovea frame.

The high-resolution fovea frame is provided to an ISP core 1144 that is configured to perform offline enhancement. The low-resolution peripheral frame is provided to an ISP core 1146 that is configured to perform offline enhancement, such as upscaling and other functions. As noted above, the low-resolution peripheral frame has lower saliency and processing may be limited as compared to the high-resolution fovea frame.

The reading of the compressed fovea frame and the low-resolution peripheral frame can reduce the number of read and corresponding write operations of the memory 1030, which can reduce the power consumption of the XR system 1000. In some aspects, the memory 1030 may also have insufficient bandwidth due to the size of the image streams and the frame rate. Compressing the fovea region can reduce the memory bandwidth consumed by this operation and prevent degradation of the XR system 1000 operation. For example, the XR system 1000 may skip frames if the bandwidth of the memory 1030 is exceeded. Skipping frames can create visual artifacts, decrease the playback experience, and increase latency.

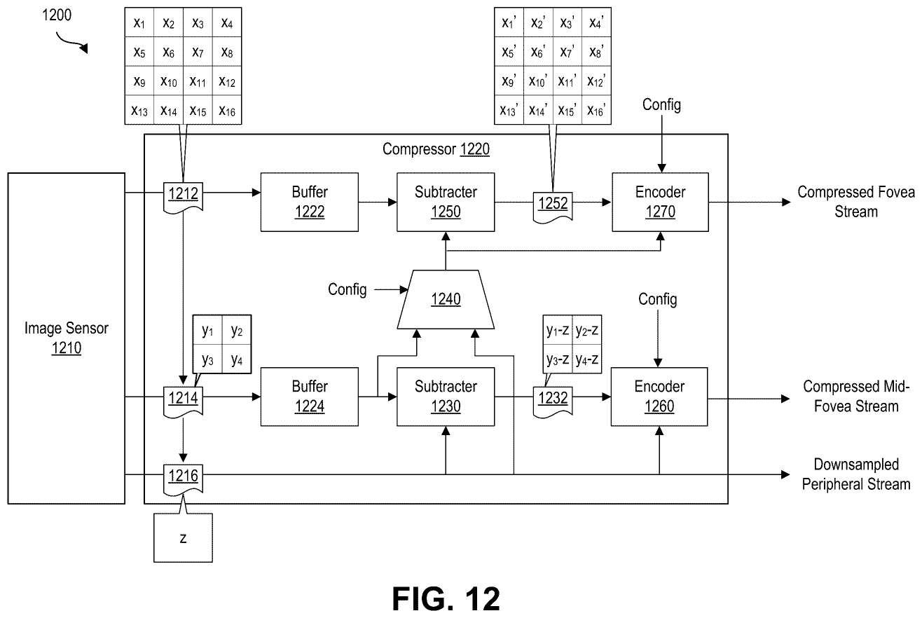

FIG. 12 is a block diagram illustrating an example of an XR system 1200 with multi-fovea compression in accordance with some aspects of the disclosure. In some aspects, the XR system 1200 includes an image sensor 1210 that is configured to generate at least a high-resolution fovea frame 1212, a mid-resolution fovea-frame 1214, and a low-resolution peripheral frame 1216. Alignment buffers in XR system 1200 are omitted to simplify the illustration and are needed for the reasons described above.

The XR system 1200 includes a compressor 1220 configured to compress at least the high-resolution fovea frame 1212 and the mid-resolution fovea-frame 1214. The compressor 1220 is shown as being separate from the image sensor 1210 for illustrative purposes only and the compressor 1220 may be integrated into the image sensor 1210. The compressor 1220 may also be part of an ISP.

A portion of the high-resolution fovea frame 1212 is illustrated and is represented by pixels [x1, x2, . . . x16], and the image sensor 1210 may downsample the pixels [x1, x2, . . . x16] into the mid-resolution fovea-frame 1214 represented by pixels [y1, y2 . . . y4]. The mid-resolution fovea-frame 1214 (or the high-resolution fovea frame 1212) is also downsampled in the image sensor 1210 into the low-resolution peripheral frame 1216 and represented by pixel [z]. The high-resolution fovea frame 1212 is provided to a buffer 1222 and the mid-resolution fovea-frame 1214 is provided to a buffer 1224 to synchronize the frames temporally. The mid-resolution fovea-frame 1214 is then provided to a subtractor 1230, which subtracts corresponding pixels of the low-resolution peripheral frame 1216 from the mid-resolution fovea-frame 1214, yielding differential pixels 1232. As noted above, the subtractor 1230 may perform a transfer function, and a subtraction is illustrated for purposes of clarity. In this case, the differential pixels are represented by [(y1−z), (y2−z) . . . (y4−z)].

The high-resolution fovea frame 1212 is provided to a subtractor 1250, which also receives input from a selector 1240. In this case, the mid-resolution fovea-frame 1214 and the low-resolution peripheral frame 1216 are provided to a selector 1240 and the selector 1240 selects values to apply to the subtractor 1250 based on timing, texture, and noise. The values of the high-resolution fovea frame 1212 and the mid-resolution fovea-frame 1214 are then subtracted from the high-resolution fovea frame 1212 to yield differential pixels 1252, which are represented by [x1′, x2′ . . . x16′].

The yielding differential pixels 1232 is provided to an encoder 1260, which may compress or encode the yielding differential pixels 1232 based on the low-resolution peripheral frame 1216. For example, the encoder 1260 may encode the yielding differential pixels 1232 as a tuple with the first value corresponding to yielding differential pixels 1232 and the second value corresponding to mid-resolution fovea-frame 1214 (e.g., {[(y1−z), (y2−z) . . . (y4−z]), z}. In this case, the square brackets identify an array, and the curly bracket identifies a tuple of values. The encoder 1260 produces a compressed mid-fovea stream that has a first level of compression based on a downsampling factor (e.g., 2:1).

The yield differential pixels 1252 is provided to an encoder, which uses the output of the selector 1240 to encoder 1270, which generates a compressed fovea stream. In this case, the XR system 1200 is configured to generate multiple compressed fovea streams. The multiple streams may provide a gradient of resolutions, which can further compress the images. For example, the compressed fovea stream may have a smaller FOV as compared to a single level of fovea compression in FIG. 7, which may be able to further reduce the compression and reduce bandwidth and power.

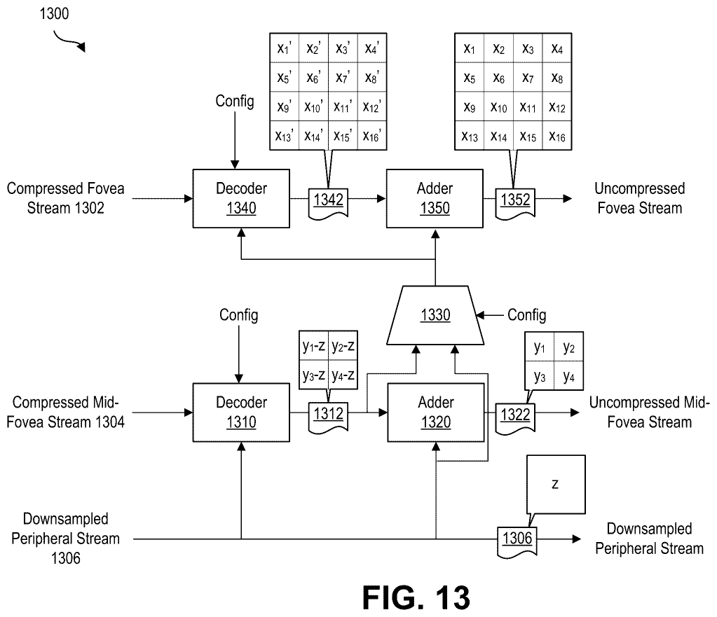

FIG. 13 is a block diagram illustrating an example of an XR system 1300 with multi-fovea decompression in accordance with some aspects of the disclosure. In some aspects, the XR system 1300 is configured to receive a compressed fovea stream 1302, a compressed mid-fovea stream 1304, and a downsampled peripheral stream 1306 corresponding to a scene captured by an image sensor (e.g., the image sensor 1210 in FIG. 12).

The compressed mid-fovea stream 1304 and the downsampled peripheral stream 1306 are provided to a decoder 1310 to decompress the compressed mid-fovea stream 1304. In some cases, the compressed mid-fovea stream 1304 can be compressed by lossy or lossless compression algorithms. A configuration signal (CONFIG) is input to the decoder 1310 for dynamic control of the decoding/decompression by the decoder 1310. For example, the configuration signal may include timing information that enables the components in FIG. 13 to provide correct information. The decoder 1310 generates differential pixels 1312 [(y1−z), (y2−z) . . . (y4−z)] based on the compressed fovea stream 1302 and the compressed mid-fovea stream 1304, which are provided to an adder 1320 to recover an uncompressed mid-fovea stream 1322 (e.g., the second fovea region 614 in FIG. 6B). For example, the uncompressed mid-fovea stream 1322 is represented by pixels [y1, y2 . . . y4].

The downsampled peripheral stream 1306 and the decoder 1310 generate differential pixels 1312 and may also be able to input into a selector 1330 (e.g., a multiplexer) that is configured to select values from the downsampled peripheral stream 1306 and the decoder 1310 generates differential pixels 1312 to output to a decoder 1340 and an adder 1350.

The compressed fovea stream 1302 is provided to the decoder 1340, and the decoder 1340 decodes and/or decompresses the compressed fovea stream 1302 based on the signal selected from the downsampled peripheral stream 1306 and the decoder 1310 generates differential pixels 1312. For example, the decoder 1340 generates differential pixels 1342 as shown in FIG. 13, which is represented by values [x1′, x2′ . . . x16′]. The decoder 1310 generates differential pixels 1312 are provided to the adder 1350, which adds a common value associated with the pixels based on the decoder 1310 generates differential pixels 1312 and the downsampled peripheral stream 1306 as selected by the selector 1330. In some aspects, the adder 1350 recovers an uncompressed fovea stream 1352, which is represented by values [x1, x2 . . . x16].

In some aspects, the downsampled peripheral stream 1306, the uncompressed mid-fovea stream 1322, and the uncompressed fovea stream 1352 are provided to a blending engine or corresponding function to synthesize a single image having different regions of photometric quality based on the foveation. For example, a peripheral region (e.g., a background) corresponding to the downsampled peripheral stream 1306 may be upscaled and have lower fidelity as compared to a fovea region, but the peripheral region is out of focus for a user and does significantly affect user experience. Similarly, a fovea region (e.g., the uncompressed fovea stream 1352) maintains fidelity and user experience is maintained. The XR system 1300 thereby is able to decompress multiple regions (e.g., three or more) with different levels of compression and/or encoding to preserve bandwidth and power. For example, the compression reduces the bandwidth of display buses and memory buses and also provides corresponding power savings because reading/writing operations in memory consume power.

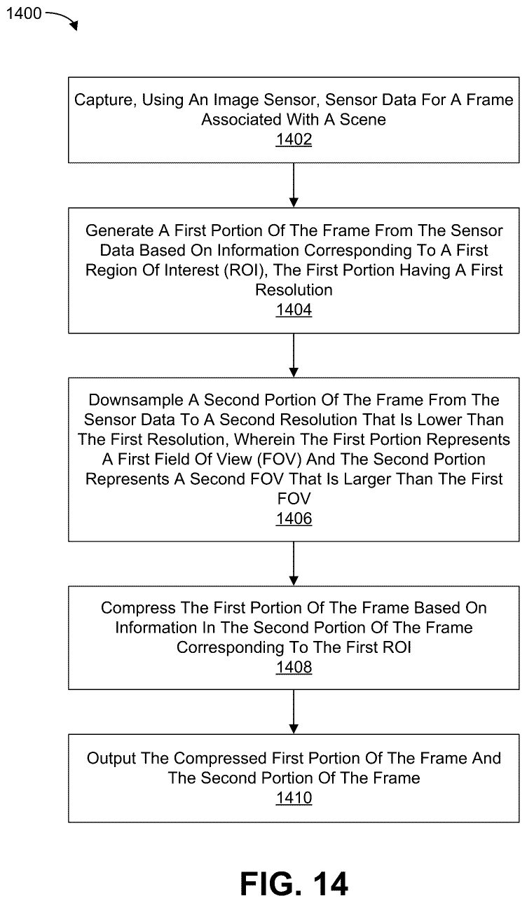

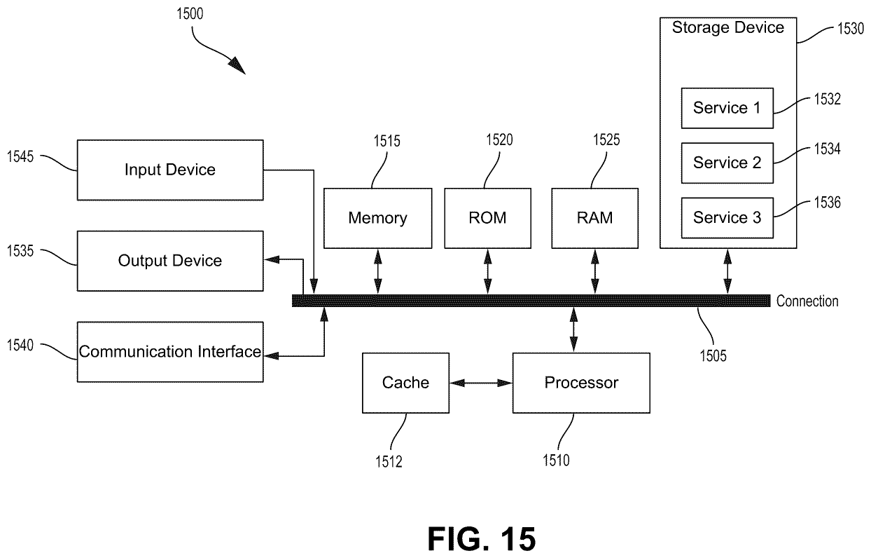

FIG. 14 is a flowchart illustrating an example process 1400 for processing images in accordance with aspects of the present disclosure. The process 1400 can be performed by a computing device (or apparatus) or a component (e.g., a chipset, codec, etc.) of the computing device. In some aspects, the computing device may include an ISP. The computing device may be a mobile device (e.g., a mobile phone), a network-connected wearable such as a watch, an XR device (e.g., a VR device or AR device), a vehicle or component or system of a vehicle, or other types of computing device. The operations of the process 1400 may be implemented as software components that are executed and run on one or more processors (e.g., CPU 102, GPU 104, DSP 106, and/or NPU 108 of FIG. 1, the processor 1510 of FIG. 15, or other processor(s)). Further, the transmission and reception of signals by the computing device in the process 1400 may be enabled, for example, by one or more antennas, one or more transceivers (e.g., wireless transceiver(s)), and/or other communication components of the computing device.

At block 1402, the computing device (or component thereof) may capture, using an image sensor (or obtain from the image sensor), sensor data (e.g., sensor data 503, 504 of FIG. 5) for a frame associated with a scene.

At block 1404, the computing device (or component thereof) may generate a first portion of the frame from the sensor data based on information corresponding to a first ROI. The first portion have a first resolution and may represent a first FOV. The first portion may also be referred to a fovea region (e.g., fovea region 604 region).

At block 1406, the computing device (or component thereof) may downsample a second portion of the frame from the sensor data to a second resolution that is lower than the first resolution. The second portion represents a second FOV that is larger than the first FOV, and may also be referred to as a peripheral region (e.g., the low-resolution peripheral frame 714 of FIG. 7). In some cases, the peripheral region also includes pixels from the fovea region. In some aspects, the pixels corresponding to the fovea region from the lower-resolution peripheral region can be used to compress corresponding pixels from the higher-resolution fovea region.

At block 1408, the computing device (or component thereof) may compress (e.g., using the compressor 720 of FIG. 7) the first portion of the frame based on information in the second portion of the frame corresponding to the first ROI. For example, the computing device (or component thereof) may, for a group of pixels in the frame, subtract, from each pixel in the group of pixels, a value of a pixel in the second portion of the frame to generate a respective residual value for each pixel in the group of pixels. The computing device (or component thereof) may also encode the group of pixels in the frame using a compression algorithm.

In some aspects, block 1408 can be performed by an image sensor of the computing device. For example, the image sensor outputs the compressed first portion of the frame and the second portion of the frame to an image signal processor. In other aspects, block 1408 can be performed by an image sensor processor of the computing device. For example, the image signal processor of the computing device can output the compressed first portion of the frame and the second portion of the frame to a frame buffer.

At block 1410, the computing device (or component thereof) output the compressed first portion of the frame and the second portion of the frame. For example, the computing device (or component thereof) can output the compressed first portion of the frame and the second portion of the frame to other components of the computing device. For example, a GPU can receive both the compressed first portion of the frame and the second portion of the frame and blend the images together into a single frame, supplement the single image with virtual content, and present the single frame with virtual content to a user. For example, the computing device can be implemented in an XR device.

The computing device (or component thereof) may be configured to decompress the compressed first portion of the frame based on information in the second portion of the frame corresponding to the first ROI. For example, to decompress the compressed first portion, the computing device (or component thereof) may, for a group of residual values for the compressed first portion, add, to each value in the group of residual values, a value of a pixel in the second portion of the frame to generate a reconstructed pixel value for each residual value in the group of residual values.

The computing device (or component thereof) may also decompress the compressed first portion of the frame based on the second portion of the frame; and synthesize the first portion of the frame and the second portion of the frame into a single frame. In some cases, an image signal processor decompresses the compressed first portion of the frame and processes the first portion of the frame based on the second portion of the frame at a front end of the image signal processor. In other cases, an image signal processor decompresses the compressed first portion of the frame and processes the first portion of the frame based on the second portion of the frame at an offline engine of the image signal processor.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The process 1400 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which may be for example any computing device making up internal computing system, a remote computing system, a camera, or any component thereof in which the components of the system are in communication with each other using connection 1505. Connection 1505 may be a physical connection using a bus, or a direct connection into processor 1510, such as in a chipset architecture. Connection 1505 may also be a virtual connection, networked connection, or logical connection.

In some embodiments, computing system 1500 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1500 includes at least one processing unit (CPU or processor) 1510 and connection 1505 that communicatively couples various system components including system memory 1515, such as ROM 1520 and RAM 1525 to processor 1510. Computing system 1500 may include a cache 1512 of high-speed memory connected directly with, in close proximity to, or integrated as part of processor 1510.

Processor 1510 may include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which may represent any number of input mechanisms, such as a microphone for speech, a touch-sensitive screen for gesture or graphical input, keyboard, mouse, motion input, speech, etc. Computing system 1500 may also include output device 1535, which may be one or more of a number of output mechanisms. In some instances, multimodal systems may enable a user to provide multiple types of input/output to communicate with computing system 1500.

Computing system 1500 may include communications interface 1540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (LA) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510, it causes the system to perform a function. In some embodiments, a hardware service that performs a particular function may include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method of generating one or more frames, comprising: capturing, using an image sensor, sensor data for a frame associated with a scene; generating a first portion of the frame from the sensor data based on information corresponding to a first ROI, the first portion having a first resolution; downsampling a second portion of the frame from the sensor data to a second resolution that is lower than the first resolution, wherein the first portion represents a first FOV and the second portion represents a second FOV that is larger than the first FOV; compressing the first portion of the frame based on information in the second portion of the frame corresponding to the first ROI; and outputting the compressed first portion of the frame and the second portion of the frame.

Aspect 2. The method of Aspect 1, wherein compressing the first portion comprises, for a group of pixels in the frame: subtracting, from each pixel in the group of pixels, a value of a pixel in the second portion of the frame to generate a respective residual value for each pixel in the group of pixels.

Aspect 3. The method of Aspect 2, wherein compressing the first portion further comprises: encoding the group of pixels in the frame using a compression algorithm.

Aspect 4. The method of any of Aspects 1 to 3, further comprising decompressing the compressed first portion of the frame based on information in the second portion of the frame corresponding to the first ROI.

Aspect 5. The method of Aspect 4, wherein decompressing the compressed first portion comprises, for a group of residual values for the compressed first portion: adding, to each value in the group of residual values, a value of a pixel in the second portion of the frame to generate a reconstructed pixel value for each residual value in the group of residual values.

Aspect 6. The method of any of Aspects 1 to 5, wherein the image sensor outputs the compressed first portion of the frame and the second portion of the frame to an image signal processor.

Aspect 7. The method of any of Aspects 1 to 6, wherein an image signal processor outputs the compressed first portion of the frame and the second portion of the frame to a frame buffer.

Aspect 8. The method of any of Aspects 1 to 7, further comprising: decompressing the compressed first portion of the frame based on the second portion of the frame; and synthesizing the first portion of the frame and the second portion of the frame into a single frame.

Aspect 9. The method of Aspect 8, wherein an image signal processor decompresses the compressed first portion of the frame and processes the first portion of the frame based on the second portion of the frame at a front end of the image signal processor.

Aspect 10. The method of any of Aspects 8 or 9, an image signal processor decompresses the compressed first portion of the frame and processes the first portion of the frame based on the second portion of the frame at an offline engine of the image signal processor.

Aspect 11. An apparatus for generating one or more frames, the apparatus comprising: at least one memory; and at least one processor coupled to the at least one memory and configured to: capture, using an image sensor, sensor data for a frame associated with a scene; generate a first portion of the frame from the sensor data based on information corresponding to a first ROI, the first portion having a first resolution; downsample a second portion of the frame from the sensor data to a second resolution that is lower than the first resolution, wherein the first portion represents a first FOV and the second portion represents a second FOV that is larger than the first FOV; compress the first portion of the frame based on information in the second portion of the frame corresponding to the first ROI; and output the compressed first portion of the frame and the second portion of the frame.

Aspect 12. The apparatus of Aspect 11, wherein the at least one possessor, as part of compressing the first portion is configured to, for a group of pixels in the frame, subtract, from each pixel in the group of pixels, a value of a pixel in the second portion of the frame to generate a respective residual value for each pixel in the group of pixels.

Aspect 13. The apparatus of Aspect 12, wherein the at least one processor is configured to: encode the group of pixels in the frame using a compression algorithm.

Aspect 14. The apparatus of any of Aspects 11 to 13, wherein the at least one processor is configured to: decompress the compressed first portion of the frame based on information in the second portion of the frame corresponding to the first ROI.

Aspect 15. The apparatus of Aspect 14, wherein the at least one processor is configured to: for a group of residual values for the compressed first portion add, to each value in the group of residual values, a value of a pixel in the second portion of the frame to generate a reconstructed pixel value for each residual value in the group of residual values.

Aspect 16. The apparatus of any of Aspects 11 to 15, wherein the image sensor outputs the compressed first portion of the frame and the second portion of the frame to an image signal processor.

Aspect 17. The apparatus of any of Aspects 11 to 16, wherein an image signal processor outputs the compressed first portion of the frame and the second portion of the frame to a frame buffer.

Aspect 18. The apparatus of any of Aspects 11 to 17, wherein the at least one processor is configured to: decompress the compressed first portion of the frame based on the second portion of the frame; and synthesize the first portion of the frame and the second portion of the frame into a single frame.

Aspect 19. The apparatus of Aspect 18, wherein an image signal processor decompresses the compressed first portion of the frame and processes the first portion of the frame based on the second portion of the frame at a front end of the image signal processor.

Aspect 20. The apparatus of any of Aspects 18 to 19, wherein an image signal processor decompresses the compressed first portion of the frame and processes the first portion of the frame based on the second portion of the frame at an offline engine of the image signal processor.

Aspect 21. A non-transitory computer-readable medium having stored thereon instructions that, when executed by at least one processor, cause the at least one processor to perform operations according to any of Aspects 1 to 10.

Aspect 22. An apparatus for generating one or more frames, the apparatus including one or more means for performing operations according to any of Aspects 1 to 10.

What is claimed is:

1. A method of generating one or more frames, comprising:
capturing, using an image sensor, sensor data for a frame associated with a scene;
generating a first portion of the frame from the sensor data based on information corresponding to a first region of interest (ROI), the first portion having a first resolution;
downsampling a second portion of the frame from the sensor data to a second resolution that is lower than the first resolution, wherein the first portion represents a first field of view (FOV) and the second portion represents a second FOV that is larger than the first FOV;
compressing the first portion of the frame based on information in the second portion of the frame corresponding to the first ROI; and
outputting the compressed first portion of the frame and the second portion of the frame.

2. The method of claim 1, wherein compressing the first portion comprises, for a group of pixels in the frame:
subtracting, from each pixel in the group of pixels, a value of a pixel in the second portion of the frame to generate a respective residual value for each pixel in the group of pixels.

3. The method of claim 2, wherein compressing the first portion further comprises:
encoding the group of pixels in the frame using a compression algorithm.

4. The method of claim 1, further comprising decompressing the compressed first portion of the frame based on information in the second portion of the frame corresponding to the first ROI.

5. The method of claim 4, wherein decompressing the compressed first portion comprises, for a group of residual values for the compressed first portion:
adding, to each value in the group of residual values, a value of a pixel in the second portion of the frame to generate a reconstructed pixel value for each residual value in the group of residual values.

6. The method of claim 1, wherein the image sensor outputs the compressed first portion of the frame and the second portion of the frame to an image signal processor.

7. The method of claim 1, wherein an image signal processor outputs the compressed first portion of the frame and the second portion of the frame to a frame buffer.

8. The method of claim 1, further comprising:
decompressing the compressed first portion of the frame based on the second portion of the frame; and
synthesizing the first portion of the frame and the second portion of the frame into a single frame.

9. The method of claim 8, wherein an image signal processor decompresses the compressed first portion of the frame and processes the first portion of the frame based on the second portion of the frame at a front end of the image signal processor.

10. The method of claim 8, wherein an image signal processor decompresses the compressed first portion of the frame and processes the first portion of the frame based on the second portion of the frame at an offline engine of the image signal processor.

11. An apparatus for generating one or more frames, the apparatus comprising:
at least one memory; and
at least one processor coupled to the at least one memory and configured to:
obtain sensor data for a frame associated with a scene;
generate a first portion of the frame from the sensor data based on information corresponding to a first region of interest (ROI), the first portion having a first resolution;
downsample a second portion of the frame from the sensor data to a second resolution that is lower than the first resolution, wherein the first portion represents a first field of view (FOV) and the second portion represents a second FOV that is larger than the first FOV;
compress the first portion of the frame based on information in the second portion of the frame corresponding to the first ROI; and
output the compressed first portion of the frame and the second portion of the frame.

12. The apparatus of claim 11, wherein the at least in processor is configured to,
for a group of pixels in the frame, subtract, from each pixel in the group of pixels, a value of a pixel in the second portion of the frame to generate a respective residual value for each pixel in the group of pixels.

13. The apparatus of claim 12, wherein the at least one processor is configured to:
encode the group of pixels in the frame using a compression algorithm.

14. The apparatus of claim 11, wherein the at least one processor is configured to:
decompress the compressed first portion of the frame based on information in the second portion of the frame corresponding to the first ROI.

15. The apparatus of claim 14, wherein the at least on processor is configured to:
for a group of residual values for the compressed first portion, add, to each value in the group of residual values, a value of a pixel in the second portion of the frame to generate a reconstructed pixel value for each residual value in the group of residual values.

16. The apparatus of claim 11, further comprising an image sensor, wherein the image sensor is configured to:
capture the sensor data; and
output the compressed first portion of the frame and the second portion of the frame to an image signal processor.

17. The apparatus of claim 11, further comprising an image signal processor, wherein the image signal processor is configured to output the compressed first portion of the frame and the second portion of the frame to a frame buffer.

18. The apparatus of claim 11, wherein the at least one processor is configured to:
decompress the compressed first portion of the frame based on the second portion of the frame; and
synthesize the first portion of the frame and the second portion of the frame into a single frame.

19. The apparatus of claim 18, further comprising an image signal processor, wherein the image signal processor is configured to:
decompress the compressed first portion of the frame; and
process the first portion of the frame based on the second portion of the frame at a front end of the image signal processor.

20. The apparatus of claim 18, further comprising an image signal processor, wherein the image signal processor is configured to:
decompress the compressed first portion of the frame; and
process the first portion of the frame based on the second portion of the frame at an offline engine of the image signal processor.
